(19) United States
(12) Patent Application Publication
(10) Pub. No.: US 2006/0036424 A1
(43) Pub. Date: Feb. 16, 2006

(54) Method and apparatus for verifying resources shared by multiple processors

(76) Inventors: Jeremy P. Petsinger, Fort Collins, CO (US); Danny Kwong, Fort Collins, CO (US); Kevin David Safford, Fort Collins, CO (US)

Correspondence Address: HEWLETT-PACKARD COMPANY;Intellectual Property Administration, P.O. Box 272400, Fort Collins, CO, 80527-2400, US

(21) Appl. No.: 10/917,764

(22) Filed: Aug. 13, 2004

(51) Int. Cl. G06F 13/10

(52) U.S. Cl. 703/21

(57) ABSTRACT

Computer system models and methods for modeling computers that share resources are disclosed herein. One embodiment of the method for modeling a computer system comprises modeling a first shared resource and associating a first model of the first shared resource with a first processor model. A second model of the first shared resource is associated with a second processor model, wherein the first model of the first shared resource is substantially identical to the second model of the first shared resource. Data associated with the first model of the first shared resource is maintained to be equal to the data associated with the second model of the first shared resource.

### BACKGROUND

As computer systems become more advanced, many computer systems are using multiple processing units or processors. The use of multiple processors in a computer system significantly increases the computing power of the computer system. The computing system, however, becomes very complex when multiple processors are used. For example, the processors typically share some resources, such as portions of memory and various levels of cache.

The design of a multiprocessor computer system is typically very costly due, at least in part, to the complexity of the computer system. One technique used to minimize the cost of designing a multiprocessor computer system is to model the computer system using a computer program prior to fabricating prototypes and the like. A computer program can then simulate the operation of the multiprocessor computer system. The simulation enables the designers of the computer system to modify the design and fix problems before a costly prototype of the multiprocessor computer system is manufactured.

As multiprocessor computer systems become more sophisticated, the programs used for their simulation become more complex. For example, the programs have to simulate the shared resources. Modifications to the simulation programs that reflect design changes in the computer system tend to be very time consuming and costly.

### SUMMARY

Models and methods for modeling computer systems that share resources are disclosed herein. One embodiment of the method for modeling a computer system comprises modeling a first shared resource and associating a first model of the first shared resource with a first processor model. A second model of the first shared resource is associated with a second processor model, wherein the first model of the first shared resource is substantially identical to the second model of the first shared resource. Data associated with the first model of the first shared resource is maintained to be equal to the data associated with the second model of the first shared resource.

### BRIEF DESCRIPTION OF THE DRAWINGS

FIG. 1 is a schematic diagram of an embodiment of a multiprocessor computer system that is to be simulated.

FIG. 2 is a schematic diagram of an embodiment of a model of the multiprocessor computer system of FIG. 1.

FIG. 3 is a schematic diagram of another embodiment of a multiprocessor computer system that is to be simulated.

FIG. 4 is a schematic diagram of an embodiment of a model of the multiprocessor computer system of FIG. 3.

### DETAILED DESCRIPTION

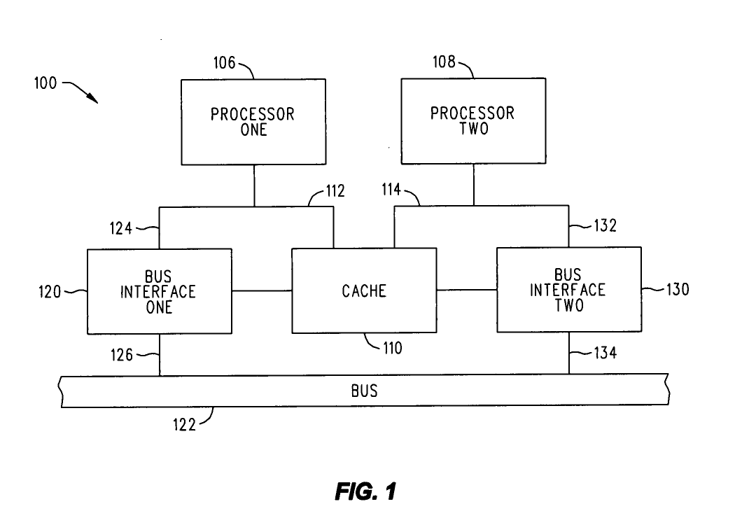

An embodiment of a multiprocessor computer system 100 is shown in FIG. 1. Other embodiments of computer systems will be described further below. The computer system 100 of FIG. 1 includes a first processor 106 and a second processor 108. The first processor 106 and the second processor 108 are sometimes referred to as processor one and processor two, respectively. The processors 106, 108 may be fabricated on the same circuit, such as the same silicon die. In other embodiments, the processors 106, 108 may be located in close proximity or on the same module.

The first processor 106 is connected to a cache 110 via a data line 112. Likewise, a data line 114 connects the second processor 108 to the cache 110. Data lines as used to describe the computer system 100 refer to any means that transfers data. Examples include single conductors or groups of conductors arranged to transmit serial or parallel data. The cache 110 is a memory device that stores data, wherein the data is accessible to both the first processor 106 and the second processor 108. The cache 110 is an example of a shared resource or a shared component that may be used by the computer system 100. The cache 110 may be fabricated with either of the processors 106, 108, or it may be fabricated as a separate device. The computer system 100 may use several different types of and hierarchical schemes of cache. In order to simplify the description of the computer system 100, the cache 110 is temporary memory accessible by both the first processor 106 and the second processor 108 and the cache 110 is not represented as any specific hierarchical scheme of cache.

A first bus interface 120 is connected between the first processor 106 and a bus 122. More specifically, a data line 124 connects the first processor 106 to the first bus interface 120 and a data line 126 connects the first bus interface 120 to the bus 122. The first bus interface 120 is sometimes referred to as bus interface one and may be an external bus or a shared bus. The first bus interface 120 contains firmware, software, or the like, which provides for data transmission to and from the bus 122 as is known in the art. The bus 122 may, as an example, be a system bus.

A second bus interface 130 is connected between the second processor 108 and the bus 122. The second bus interface 130 may be identical to the first bus interface 120. The second bus interface 130 is connected to the second processor 108 by way of a line 132. The second bus interface 130 is also connected to the bus 122 by way of a line 134.

In the embodiment of the computer system 100 shown in FIG. 1, both the first processor 106 and the second processor 108 share the cache 110. Accordingly, both the first processor 106 and the second processor 108 share the data stored in the cache 110. The same applies for other resources shared by the processors 106, 108. For example, the data stored in the cache 110 as a result of any accesses, such as reads, writes, or invalidates, performed by one of the processors on the cache 110 is accessible by the other processor. This accessibility is due to the processors 106, 108 sharing the cache 110. Thus, data stored in the cache 110 may be read by both processors 106, 108. In another example, the first processor 106 may request data for a load instruction wherein the data is not present in the cache 110. An instruction is transmitted on the bus 122 via the bus interface 120 to retrieve the data. An agent connected to the bus 122, not shown, serves to transmit the data to the cache 110, where both processors 106, 108 may access the data.

Efficiently designing the computer system 100 in FIG. 1 requires that it be modeled so that it may be simulated and tested prior to being fabricated. Due to the high cost of fabricating such a system, it is typically more efficient to model the system using a hardware description language, such as VHDL, prior to fabricating the system. Modeling enables the designers to correct errors and revise the design prior to expending the money and time fabricating the system.

Computer systems using multiple processors and shared resources, such as the computer system 100, tend to be very complex. This complexity makes the computer models very difficult to design and revise. For example, in the computer system 100 of FIG. 1, the computer model must share the data in the cache 110 with both processors 106, 108. Thus, every time the data in the cache 110 is changed, the data accessible to each of the processors 106, 108 via the cache 110 must change.

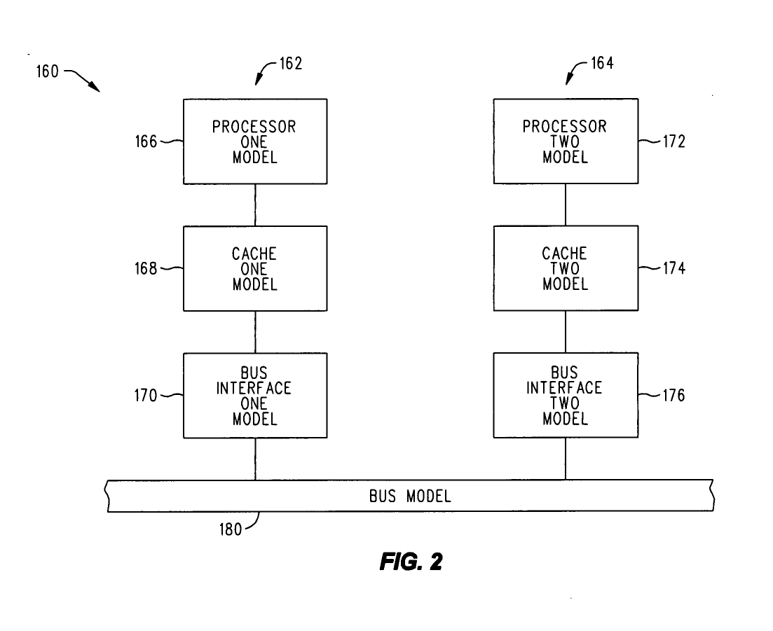

In order to overcome the above-described problems, the computer system 100 is modeled as shown by the model 160 of FIG. 2. More specifically, the model 160 depicts a computer program that simulates or models the operation of the computer system 100. Accordingly, the components shown in the schematic diagram of FIG. 2 are actually portions of a computer program that simulate corresponding components of the computer system 100. As shown in FIG. 2, the model 160 has two components or portions, which are referred to as a first portion 162 and a second portion 164. As described in greater detail below, one embodiment of the model 160 includes as many portions as the number of processors in the computer system 100 that share a resource. Each of the portions 162, 164 operates as though its corresponding processor has sole access to the shared resources and the data stored therein. In the embodiment of the computer system 100, the processor models operate as though each has sole access to the data stored in a model of the cache 110.

The first portion 162 of the model has a first processor model 166, which is sometimes referred to as processor one model. The first processor model 166 simulates the first processor 106 of FIG. 1. The first portion 162 also includes a first cache model 168 and a first bus interface model 170. The first cache model 168 is sometimes referred to as cache one model and the first bus interface model 170 is sometimes referred to as bus interface one model. The above-described components of the first portion 162 are shown as being individual components linked by lines. The components are actually part of the above-described computer program that simulates the computer system 100. For example, the components described in FIG. 2 may be modules or the like within the program.

The second portion 164 of the model 160 is similar to the first portion 162. The second portion 164 includes a second processor model 172, a second cache model 174, and a second bus interface model 176. The second processor model 172 is sometimes referred to as processor two model and simulates the second processor 108. The second bus interface model 176 is sometimes referred to as bus interface two model and simulates the second bus interface 130, FIG. 1. The second processor model 172 may differ from the first processor model 166 if the first processor 106, FIG. 1, differs from the second processor 108. The model 160 also includes a bus model 180 that simulates the bus 122, FIG. 1.

As shown in FIG. 2, the model includes a second cache model 174, which simulates the shared cache 110 of FIG. 1. The model 160 contains two cache models, the first cache model 168 and the second cache model 174, that simulate the shared cache 110 of FIG. 1. The first cache model 168 and the second cache model 174 are modeled the same and the data maintained in each cache model is maintained to be identical. For example, if data is changed in the first cache model 168, the model 160 causes the data in the second cache model 174 to be the same as the data in the first cache model 168. In addition, the first processor model 166 interacts with the first cache model 168 and not with the second cache model 174. Likewise, the second processor model interacts with the second cache model 174 and not with the first cache model 168. Thus, each processor model operates as though it has sole access to the cache.

As set forth above, the model of the cache 110 is duplicated for every processor that may share it. Accordingly, the model 160 is not required to emulate the interface between shared resources or components, such as the cache 110, and the processors. Therefore, the topology of the computer system 100 may change, which may require minimal changes to the model. For example, a third processor that shares the cache 110 may be added to the computer system 100. The model 160 does not need to emulate an interface to another cache model. Rather, a third cache model is added that is identical to the first cache model 168 and the second cache model 174. The new processor functions as though it has sole access to the new cache model.

Having described the computer system 100 and the model 160, the operation of the model 160 will now be described. The description of the operation of the model 160 will focus on the shared resource, which is the cache 110 and its models, the first cache model 168 and the second cache model 174.

Data stored in the cache 110 is accessed or processed by way of instructions, some of which are referred to herein as accesses. Accesses may include different instructions that, as examples, read, write, modify, and invalidate data stored in the cache 110. The model 160 simulates the access instructions on the first cache model 168 and the second cache model 174. In the embodiment of the computer system 100 described herein, accesses are portioned into three categories. The first category includes instructions originated by a host processor, such as the first processor 106 or the second processor 108. These accesses may load data from the cache 110 or store data to the cache 110. The second category includes instructions initiated by other processors. For purposes of the model 160 described herein, these instructions store data in the cache 110. The third category of accesses are originated by other components of the computer system 100. One example of these type of accesses are snoop instructions.

The first category of accesses may be verified using the model 160 by performing the accesses and then verifying that the correct data is stored in the first cache model 168 and the second cache model 174. For example, the first processor 106 may request data. An agent that may be associated with the first bus interface 120 retrieves the data and stores the data in the cache 110. Accordingly, the cache 110, which is accessible by both the first processor 106 and the second processor 108, has access to or otherwise stores the data. The above-described access is verified using the model 160 by having the first processor model 166 request data as described above. The first bus interface model 170 retrieves the data and stores the data in the first cache model 168. As set forth above, the first processor model 166 functions as though it has sole access to the first cache model 168. In other words, the first processor model 166 functions as though the first cache model 168 is its private cache. In order to make the model 160 appear as though the first cache model 168 and the second cache model are a shared resource, the data in the first cache model 168 is copied into the second cache model 174. Accordingly, the cache models 168, 174 store the same data and function as a single shared resource.

The category of accesses that are initiated by other processors can be divided into two subcategories. The first subcategory of accesses change the state of data stored in the shared resource, such as the cache 110. These accesses include stores, replacements, and purges.

The second subcategory of accesses that may be modeled read the data in the shared resource without modifying the data. An example of such an access is a load instruction, wherein data is loaded from the shared resource to another location without modifying the data in the shared structure. When an access of the first subcategory that modifies data stored in the shared resource is processed, the modification to the data is made to all the shared resources. For example, if a resource changes the data stored in the cache 110, the model 160 reflects this change by modifying the data stored in both the first cache model 168 and the second cache model 174. With regard to shared resources, accesses that do not modify data stored in the shared resources are not processed as described above. In other words, the model 160 need not modify the data in either the first cache model 168 or the second cache model 174 if the data is not changed.

The third category of accesses, which are originated by other components in the system 100, use the bus 122 to modify or invalidate the data stored in the cache 110. With this third category of accesses, both the first cache model 168 and the second cache model 174 modify or invalidate their data depending on the type of access made on the bus 122.

The above-described model 160 simplifies the simulation of processor circuits and the like that share resources. For example, the model 160 does not need to simulate the interface between the shared resources or the shared structure and the processors. In addition, the topology of the circuit that is to be simulated may be changed without the need to make significant changes to the model. For example processors may be added to the circuit 100 and the model 160 simply needs to add new portions as described above. When the circuit 100 is modified to add a processor, each corresponding processor in the model will have its own shared resource, which mirrors the other shared resources in the circuit 100. It should be noted that while the circuit 100 and the associated model 160 described a multiple processor circuit that shared cache, circuits that share other resources or other levels of cache may be modeled in a similar manner.

Having described some embodiments of a model and methods of modeling a circuit, other models and methods will now be described.

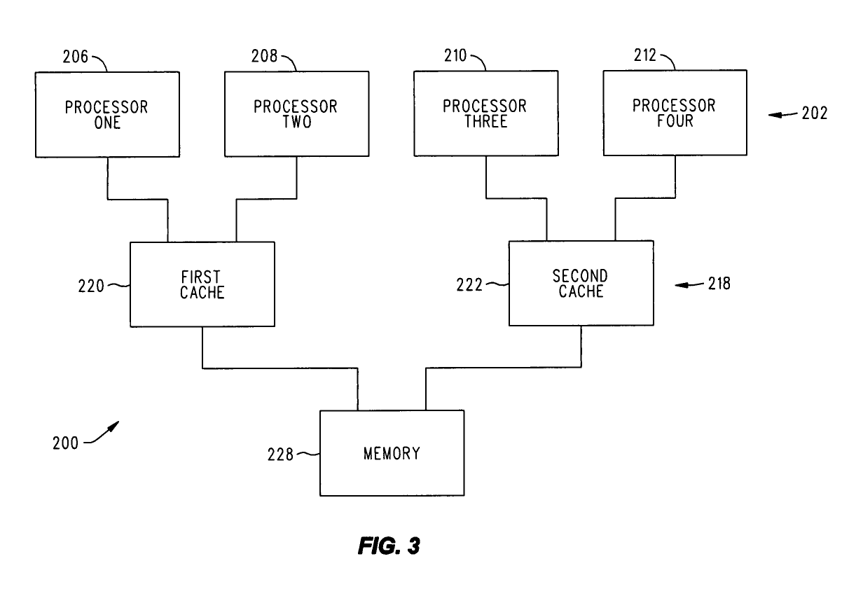

One embodiment of the above-described modeling may be used in circuits where there are several shared resources. One example of such a circuit is shown by the circuit 200 of FIG. 3. The circuit 200 includes a plurality of processors 202. The processors 202 are referred to individually as the first processor 206, the second processor 208, the third processor 210, and the fourth processor 212. The processors 202 are also referred to as processor one, processor two, processor three, and processor four, respectively. The circuit 200 includes a plurality of caches 218, which are described individually as a first cache 222 and a second cache 224. The first cache 220 and the second cache 222 are sometimes referred to as cache one and cache two, respectively. The circuit 200 also includes memory 228.

As shown in FIG. 3, the processors 202 have shared access with the cache 218 and the cache 218 has shared access with the memory 228. In the example provided by FIG. 3, the first processor 206 and the second processor 208 have shared access with the first cache 220. The third processor 210 and the fourth processor 212 have shared access with the second cache 222. The caches 218, in turn, have shared access with the memory 228.

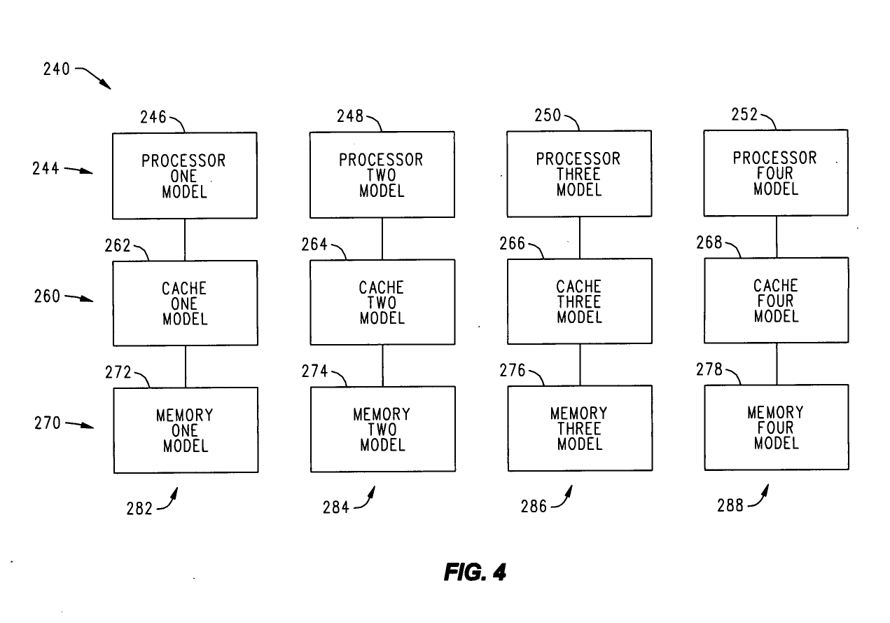

Conventional models used to simulate the circuit 200 would be extremely complex. The conventional models are also very difficult to modify to reflect changes to the circuit 200. In order to overcome these problems, a model as described above in FIG. 2 is provided as the model 240 of FIG. 4. The model 240 includes a plurality of processor models 244. With additional reference to FIG. 3, each of the processor models 244 models one of the processors 202. The processor models 244 include a first processor model 246, a second processor model 248, a third processor model 250, and a fourth processor model 252. The processor models 244 are sometimes referred to as processor one model, processor two model, processor three model, and processor four model, respectively.

The model 240 also includes a plurality of cache models 260, which model the caches 218. The cache models 260 include a first cache model 262, a second cache model 264, a third cache model 266, and a fourth cache model 268. The cache models 240 are sometimes referred to as cache model one, cache model two, cache model three, and cache model four, respectively. The first cache model 262 and the second cache model 264 are virtually identical and model the first cache 220. Likewise, the third cache model 266 and the fourth cache model 268 are virtually identical and model the second cache 222. As described in greater detail below, the data stored in the first cache model 262 and the data stored in the second cache model 264 is identical or virtually identical. Likewise, the data stored in the third cache model 266 and the data stored in the fourth cache model 268 is identical or virtually identical.

The model 240 includes a plurality of memory models 270. The memory models 270 are referred to as the first memory model 272, the second memory model 274, the third memory model 276, and the fourth memory model 278. The memory models 270 are also referred to as memory one model, memory two model, memory three model, and memory four model, respectively. The memory models 270 all model the memory 228 and the data stored in all the memory models 270 is identical or virtually identical.

As shown in FIG. 4, the model 240 is partitioned into four modules, wherein each module corresponds to one of the processors 202. A first module 282 corresponds to the first processor 206 and the first processor model 246. A second module 284 corresponds to the second processor 208 and the second processor model 248. A third module 286 corresponds to the third processor 210 and the third processor model 250. A fourth module 288 corresponds to the fourth processor 212 and the fourth processor model 252.

The models of the shared resources in the model 240 correspond to portions of the circuit 200. Thus, the first cache model 262 and the second cache model 264 model the first cache 220 of the circuit 200. The first cache model 262 and the second cache model 264 are virtually identical. Likewise, the third cache model 266 and the fourth cache model 268 model the second cache 222 of the circuit 200. The third cache model 266 and the fourth cache model 268 are virtually identical. All of the memory modules 270 model the memory 228 of the circuit 200 and are virtually identical.

As with the previous model, the processor models 244 function as though each processor model has sole access to their respective resources. As with the model 160 of FIG. 2, the data in shared resources is duplicated so that the resources function as shared resources. Thus, the data stored in the first cache model 262 is identical or virtually identical to the data stored in the second cache model 264. This process of duplicating data was described above with reference to the first cache model 168, FIG. 2, and the second cache model 174. The data stored in the third cache model 266 is identical or virtually identical to the data stored in the fourth cache model 268. The data stored in all the memory modules 270 are virtually identical to each other.

The model 240 may be modified, for the most part by simply modifying one of the modules rather than modifying the entire model or making substantial changes to the model. For example, if a processor is to be added to or removed from the circuit 200, a new module may be added or the corresponding module may be removed, respectively. The associations with the shared resources may also be modified by making slight changes to the modules. For example, if a processor needs to be associated with a different shared resource, the shared resource in the module corresponding to the processor is modified. Thus, if the third processor 210 were to be associated with the first cache 220 rather than the second cache 222, the third cache model 266 in the model 240 is simply changed. More specifically, the third cache model 266 may be changed to virtually identical to either the first cache model 262 or the second cache model 264.

The circuits and corresponding models have been described herein as sharing cache and memory. It should be noted that these descriptions provide exemplary embodiments and that other resources may be shared using the methods and models described herein. Likewise, various levels of cache or portions of memory may be shared.

What is claimed is:

1. A method for modeling a computer system comprising multiple processors and at least one shared resource, said method comprising:
modeling a first shared resource;
associating a first model of said first shared resource with a first processor model;
associating a second model of said first shared resource with a second processor model, said first model of said first shared resource being identical to said second model of said first shared resource; and
maintaining the data associated with said first model of said first shared resource equal to the data associated with said second model of said first shared resource.

2. The method of claim 1, and further comprising:
modeling a second shared resource;
associating a first model of said second shared resource with a third processor model;
associating a second model of said second shared resource with a fourth processor model, said first model of said second shared resource being identical to said second model of said second shared resource; and
maintaining the data associated with said first model of said second shared resource equal to the data associated with said second model of said second shared resource.

3. The method of claim 2, and further comprising:
modeling a third shared resource;
associating a first model of said third shared resource with said first model of said first shared resource;
associating a second model of said third shared resource with said second model of said first shared resource;
associating a third model of said third shared resource with said first model of said second shared resource;
associating a fourth model of said third shared resource with said second model of said second shared resource;
said first model of said third shared resource, said second model of said third shared resource, said third model of said third shared resource, and said fourth model of said third shared resource being substantially identical; and
maintaining the data associated with said first model of said third shared resource, the data associated with said second model of said third shared resource, the data associated with said third model of said third shared resource, and the data associated with said fourth model of said third shared resource substantially equal.

4. A method for modeling the operation of a computer system comprising multiple processors and at least one shared resource, said method comprising:
modeling a first shared resource;
associating a first model of said first shared resource with a first processor model;
associating a second model of said first shared resource with a second processor model, said first model of said first shared resource being identical to said second model of said first shared resource; and
performing a simulated access instruction on said computer system; and
changing data stored in said second resource to be the same as data stored in said first resource.

5. The method of claim 4, wherein said performing a simulated access instruction comprises performing an instruction wherein data is written to said first model of said first shared resource.

6. The method of claim 4, wherein said performing a simulated access instruction comprises performing an instruction wherein data is loaded from a location to said first model of said first shared resource.

7. A method for modeling the operation of a computer system comprising multiple processors and at least one shared resource, said method comprising:
modeling a first shared resource;
associating a first model of said first shared resource with a first processor model;
associating a second model of said first shared resource with a second processor model, said first model of said first shared resource being identical to said second model of said first shared resource;
modeling a second shared resource;
associating a first model of said second shared resource with a third processor model;
associating a second model of said second shared resource with a fourth processor model, said first model of said second shared resource being identical to said second model of said second shared resource; and
performing a simulated access instruction on said computer system.

8. The method of claim 7, wherein said performing a simulated access instruction comprises performing an instruction wherein data is written to said first model of said first shared resource and further comprising maintaining the data in said second model of said first shared resource to be equal to the data in said first model of said first shared resource.

9. The method of claim 7, wherein said performing a simulated access instruction comprises performing an instruction wherein data is loaded to said first model of said first shared resource from a location and further comprising maintaining the data in said second model of said first shared resource to be equal to the data in said first model of said first shared resource.

10. The method of claim 7, and further comprising:
modeling a third shared resource;
associating a first model of said third shared resource with said first model of said first shared resource;
associating a second model of said third shared resource with said second model of said first shared resource;
associating a third model of said third shared resource with said first model of said second shared resource; and
associating a fourth model of said third shared resource with said second model of said second shared resource;
said first model of said third shared resource, said second model of said third shared resource, said third model of said third shared resource, and said fourth model of said third shared resource being substantially identical.

11. The method of claim 10, wherein said performing a simulated access instruction comprises performing an instruction wherein data is written to said first model of said third shared resource and further comprising maintaining the data in said second model of said third shared resource, the data in said third model of said third shared resource, and the data in said fourth model of said third shared resource to be equal to the data in said first model of said third shared resource.

12. The method of claim 10, wherein said performing a simulated access instruction comprises performing an instruction wherein data is loaded from a location to said first model of said third shared resource and further comprising maintaining the data in said second model of said third shared resource, the data in said third model of said third shared resource, and the data in said fourth model of said third shared resource to be equal to the data in said first model of said third shared resource.

13. A model of a computer system comprising:
a first model of a first shared resource associated with a model of a first processor; and
a second model of said first shared resource associated with a model of a second processor, wherein said first model of said first shared resource is substantially identical to said second model of said first shared resource;
wherein data associated with said first model of said first shared resource and data associated with said second model of said first shared resource are maintained to be equal.

14. The model of claim 13 and further comprising:
a first model of a second shared resource associated with a model of a third processor; and
a second model of said second shared resource associated with a model of a second processor, wherein said first model of said second shared resource is substantially identical to said second model of said second shared resource;
wherein data associated with said first model of said second shared resource and data associated with said second model of said second shared resource are maintained to be equal.

15. The model of claim 14 and further comprising:
a first model of a third shared resource associated with said first model of said first shared resource;
a second model of said third shared resource associated with said second model of said first shared resource;
a third model of said third shared resource associated with said first model of said second shared resource; and
a fourth model of said third shared resource associated with said second model of said second shared resource;
wherein data associated with said first model of said third shared resource, said second model of said third shared resource, said third model of said third shared resource, and said fourth model of said third shared resource are maintained to be equal.
